(19) United States
(12) Patent Application Publication
(10) Pub. No.: US 2009/0062989 A1
(43) Pub. Date: Mar. 5, 2009

(54) Seat device for vehicle

(75) Inventors: Morio Sakai, Aichi-ken (JP); Hideo Haneda, Aichi-ken (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/919,980

(22) PCT Filed: May 18, 2006
(86) PCT No.: PCT/JP2006/309969

§ 371 Date: Nov. 6, 2007

(30) Foreign Application Priority Data
May 25, 2005 (JP) 2005-152645
Jul. 20, 2005 (JP) 2005-210411

(51) Int. Cl. B60N 2/427; B60R 21/013; B60R 21/055

(52) U.S. Cl. 701/45; 297/216.12

(57) ABSTRACT

A headrest 5 includes a base portion 5a and a movable portion 5b, which is movable relative to the base portion 5a. The movable portion 5b is moved and driven by a drive unit 8a between a retracted position 5X proximate to the base portion 5a and an extended position 5Y distant from the base portion 5a. A control unit 7 controls the drive unit 8a to move the movable portion 5b toward the extended position 5Y when determining that a vehicle occupant seated on the seat 3 caused movement of the load applied to a seating surface 3a of the seat 3.

### FIELD OF THE INVENTION

The present invention relates to a seat apparatus for a vehicle such as an automobile.

### BACKGROUND OF THE INVENTION

When an impact is applied to a vehicle from the rear, the body of a vehicle occupant above the waist will suddenly be moved rearward toward a seat back if the seat back is not supporting the vehicle occupant above the waist. In this case, the sudden movement causes the vehicle occupant's head to move rearward to a position where a headrest is located. Further rearward movement is restricted as the vehicle occupant's head comes into contact with the headrest. Afterwards, the vehicle occupant's body above the waist is thrown forward due to the reaction of the impact force. This applies a load to the vehicle occupant's neck that may result in a whiplash injury. In such a case, movement of the headrest toward the front of the vehicle relative to the seat back prevents the vehicle occupant's head from being moved over a long distance and thus protects the vehicle occupant's head and reduce the load applied to the vehicle occupant's neck. This would prevent whiplash injuries. Accordingly, there has been a proposal for moving the headrest toward the front of the vehicle when a crash occurs at the rear of the vehicle.

For example, Patent document 1 describes an automobile seat having a lever link mechanism for moving a headrest and a pressure receiving unit that is moved when receiving load applied to the front surface of a seat back. The lever link mechanism increases (amplifies) the movement amount of the pressure receiving unit. This enables the headrest to move more than the pressure receiving unit. With this structure, the forward movement amount of the headrest is greater than the movement amount of vehicle occupant's body above the waist. Thus, the load applied to the vehicle occupant's head is reduced.

Patent document 2 proposes a headrest apparatus including a pair of left and right headrests that are pivotal toward the front of the vehicle, a lock mechanism for restricting the pivoting of the headrests, and a film-like body that extends between the headrests when the two members are pivoted toward the front of the vehicle. This apparatus further includes a control means for unlocking the lock mechanism when a sensor located at the rear part of the vehicle detects an impact applied from the rear of the vehicle. With this structure, when a vehicle collision occurs, the left and right headrests are pivoted to the front of the vehicle and the film-like body is extended between the headrests. This securely and quickly restrains the vehicle occupant's head.

However, in the structure of Patent document 1, an appropriate load may not be applied to the pressure receiving unit during a vehicle collision depending on the build and posture of the vehicle occupant seated on the seat. As a result, normal movement of the headrests may be hindered. Also, in the structure of Patent document 2, an impact may not be accurately detected due to factors such as the size of the colliding vehicle. In such a case, the headrests may not be operated normally.

It is necessary to securely protect the vehicle occupant's head regardless of the build and posture of the vehicle occupant. However, when the vehicle occupant seated on a vehicle seat has a small build and the head is located below the headrest, the vehicle occupant's head cannot be protected even when the headrest moves forward.

Further, if a child restraint system (CRS) or a booster seat is mounted on the vehicle seat and if the CRS or booster seat has a height reaching the headrest, the CRS or booster seat may be pushed out when the headrest moves forward. Even if the headrest is move forward normally, the headrest is set to operate in accordance with a vehicle occupant who is directly seated on the vehicle seat. Thus, the headrest would not be able to appropriately protect the head of a vehicle occupant sitting on the CRS or the booster seat.
Patent Document 1: Japanese Laid-Open Patent Publication No. 2000-211410
Patent Document 2: Japanese Laid-Open Patent Publication No. 2003-54343

### DISCLOSURE OF THE INVENTION

It is an objective of the present invention to provide a vehicle seat apparatus having a headrest operated in a further proper manner.

To achieve the above objective, the present invention provides a vehicle seat apparatus. The seat apparatus includes a seat having a seating surface, a seat back, a headrest, a drive means, a load detection means, and a control means. The seat back is arranged at a rear part of the seat. The headrest is supported by the seat back and includes a base portion and a movable portion that is movable relative to the base portion. The movable portion moves between a retracted position proximate to the base portion and an extended position distant from the base portion. The drive means drives the movable portion. The load detection means detects a load applied to the seating surface of the seat. The control means determines from a detection signal input by the load detection means whether or not the load applied to the seating surface by a vehicle occupant seated on the seat has moved. The control means controls the drive means to move the movable portion toward the extended position when determining that the load applied to the seating surface has moved.

### BRIEF DESCRIPTION OF THE DRAWINGS

FIG. 1 is a schematic view of a vehicle seat apparatus according to a first embodiment of the present invention.

FIGS. 2(a) and 2(b) are diagrams illustrating how load is applied to a seating surface of a seat in the vehicle seat apparatus of FIG. 1.

FIG. 3 is a block diagram illustrating the electrical configuration of the vehicle seat apparatus of FIG. 1.

FIG. 4 is a flowchart illustrating the processing executed by the vehicle seat apparatus of FIG. 1.

FIG. 5(a) is a side view showing a vehicle seat apparatus according to a second embodiment of the present invention.

FIG. 5(b) is a plane view showing the vehicle seat apparatus of FIG. 5(a).

FIG. 6 is a block diagram illustrating the electrical configuration of the vehicle seat apparatus of FIG. 5(a).

FIG. 7 is a flowchart illustrating the processing executed by the vehicle seat apparatus of FIG. 5(a).

### DETAILED DESCRIPTION OF THE PREFERRED EMBODIMENTS

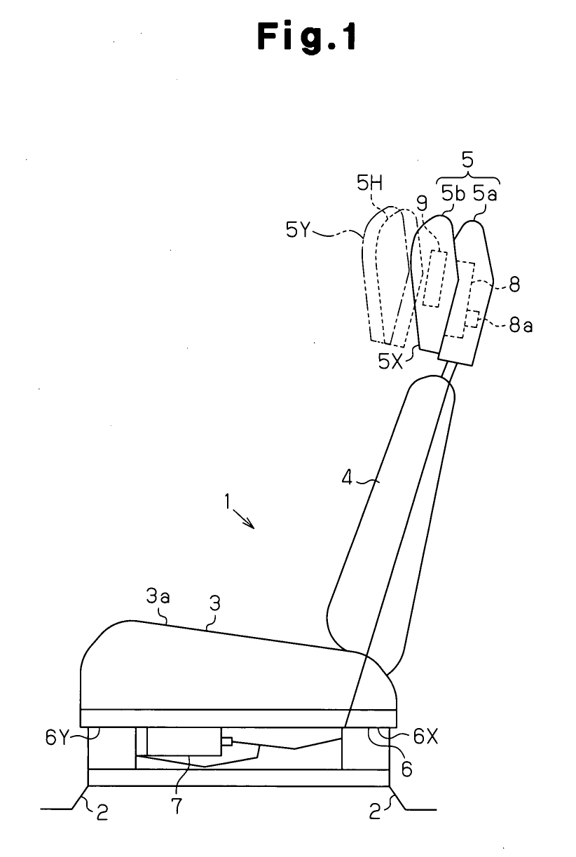

A first embodiment of the present invention will now be described with reference to FIGS. 1 to 4.

As shown in FIG. 1, a vehicle seat apparatus 1 includes a seat 3, a seat back 4 located at the rear of the seat 3, and a headrest 5 supported by the seat back 4. The seat 3 is fixed to a seat bracket 2, which is secured to a vehicle body.

The seat bracket 2 is provided with a load sensor device 6, which functions as a load detection means (load detection unit) that detects the load applied to a seating surface 3a of the seat 3, and an ECU 7, which functions as a control means (control unit) connected to the sensor device 6.

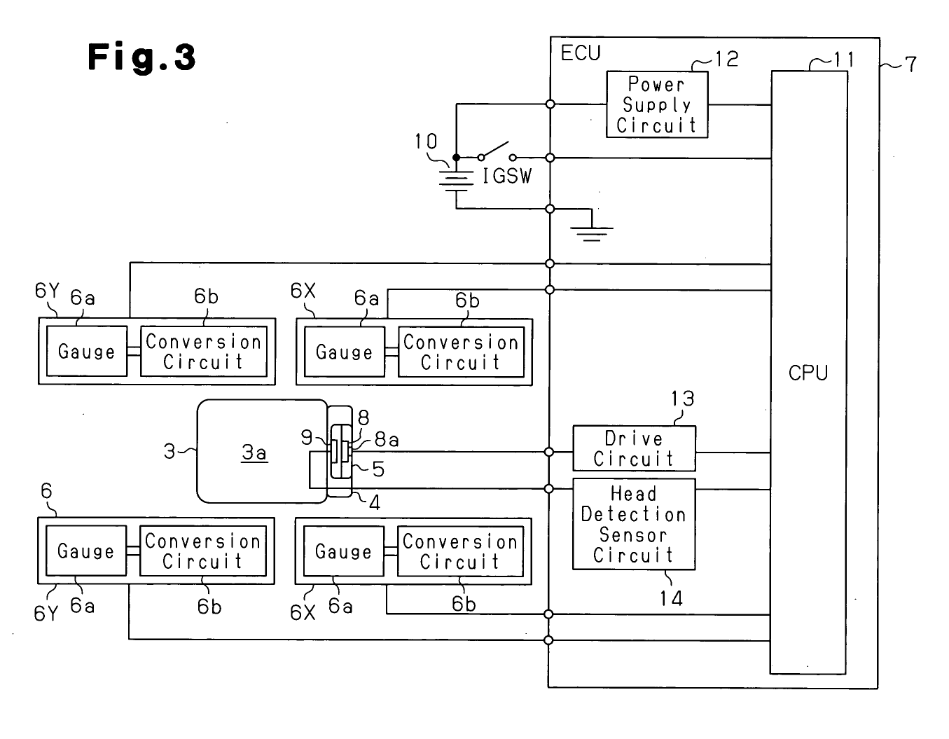

The load sensor device 6 includes two first load sensors 6X located near the seat back 4 and two second sensors 6Y spaced from the seat back 4 (see FIG. 3). The first and second sensors 6X and 6Y are respectively arranged at the four corners of the seating surface 3a. In response to an input of a detection signal output from the sensor device 6, the ECU 7 determines from the detection signal whether or not there was movement in the load applied to the seating surface 3a by a vehicle occupant seated on the seat 3 due to the impact applied to the vehicle.

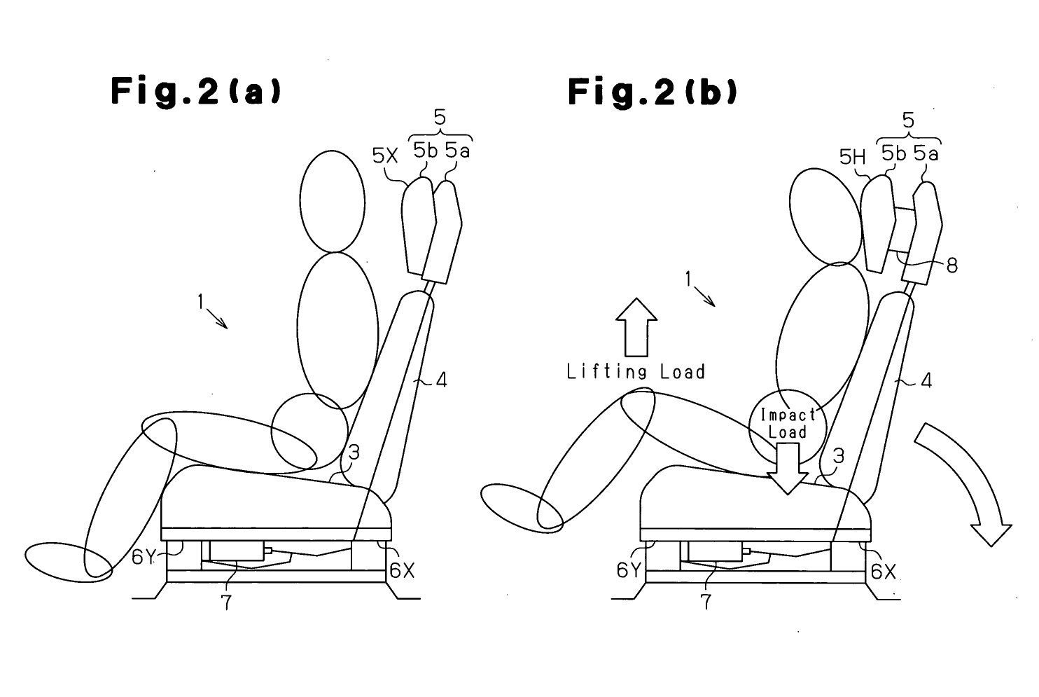

A case in which impact is applied to the vehicle from the rear when the vehicle occupant is seated on the vehicle seat apparatus 1 as shown in FIG. 2(a) will now be discussed.

If the vehicle seat apparatus 1 is, for example, a front vehicle occupant's seat or a driver's seat arranged such that the seated vehicle occupant faces toward the front of the vehicle, when an impact is applied to the vehicle from the rear, an impact is applied to the vehicle seat apparatus 1 from the rear (from the seat back 4). As a result, as shown in FIG. 2(b), the vehicle occupant's body above the waist is entirely forced against the seat back 4 with the vehicle occupant's head remaining at the same position. At the same time, the vehicle occupant's buttocks are forced against the seating surface 3a of the seat 3, and the vehicle occupant's legs are thrown upward away from the seating surface 3a of the seat 3. This causes weight movement of the vehicle occupant on the seating surface 3a of the seat 3.

In this state, an upward load, or lifting load, is applied to the second sensors 6Y located toward the front of the vehicle. A predetermined lifting load threshold is set for the ECU 7 based on the load of the vehicle occupant detected by the load sensor device 6 under a normal driving state. When the load detected by the second sensors 6Y reaches the lifting load threshold, the ECU 7 determines that there was movement in the load applied to the seating surface 3a.

Further, a large downward load, or impact load, is applied to the first sensors 6X located toward the rear of the vehicle. A predetermined impact load threshold is set for the ECU 7 based on the load of the vehicle occupant detected by the load sensor device 6 under the normal driving state. When the load detected by the first sensors 6X reaches the impact load threshold, the ECU 7 determines that there was movement in the load applied to the seating surface 3a. The lifting load threshold and the impact load threshold are set at a value that would never be detected under any condition when the vehicle is in the normal driving state, for example, about 130 kg.

If the vehicle seat apparatus 1 is, for example, a rotational seat employed as a rear seat and arranged so that the seated vehicle occupant faces the rear of the vehicle, when an impact is applied to the vehicle seat apparatus 1 from the rear, impact is applied from the front of the seat apparatus 1 (from the side opposite the seat back 4). As a result, the vehicle occupant's body above the waist is thrown forward while being restrained by a seat belt.

In this state, a load equivalent to above-described impact load is applied to the first load sensors 6X located toward the front of the vehicle. A load equivalent to the above described lifting load is applied to the second load sensors 6Y located toward the rear of the vehicle. Accordingly, when the load detected by the first load sensors 6X reaches the impact load threshold or when the load detected by the second load sensors 6Y reaches the lifting load threshold, the ECU 7 determines that there was movement in the load applied to the seating surface 3a.

As described above, when an impact is applied to the vehicle from the rear, the ECU 7 properly determines whether or not there was movement in the load applied to the seating surface 3a by the impact, regardless of whether the vehicle seat apparatus 1 is arranged such that the seated vehicle occupant faces toward the front of the vehicle or the rear of the vehicle.

The ECU 7 also determines the seated state, such as the build, weight, posture, and center of gravity position, of the vehicle occupant seated on the seat 3 based on the detection signals input from the sensor device 6. The ECU 7 compares a predetermined pressure distribution of the seating surface 3a of the seat 3 with the distribution of the load detected by the sensor device 6 to determine, for example, whether the seated vehicle occupant is an adult or a child, whether a child seat is mounted, where the center of gravity position of the vehicle occupant is located with respect to the forward/rearward direction of the vehicle.

The headrest 5, which is divided into two in the forward/rearward direction of the vehicle, includes a headrest rear portion 5a serving as a base portion and a headrest front portion 5b serving as a movable portion that is movable relative to the headrest rear portion 5a.

The headrest front portion 5b is movable between a retracted position 5X proximate to the headrest rear portion 5a as shown by the solid line in FIG. 1 and an extended position 5Y distant from the headrest rear portion 5a as shown by the double-dashed line in FIG. 1. The headrest front portion 5b is positioned at the retracted position 5X when the vehicle is in the normal driving state.

The ECU 7 sets the timing for starting the movement of the headrest front portion 5b toward the extended position 5Y, the movement speed and movement distance of the headrest front portion 5b, and the like in accordance with the determination result of the seated state that is based on the detection signals from the sensor device 6. For example, the ECU 7 sets the movement start timing, movement speed, and movement distance of the headrest front portion 5b in accordance with the build of the vehicle occupant seated on the seat 3. Further, the ECU 7 prohibits movement of the headrest front portion 5b when a child seat is mounted and shortens the movement distance of the headrest front portion 5b when the center of gravity of the vehicle occupant seated on the seat 3 is located at a relatively frontward position.

When the ECU 7 determines movement of the load applied to the seating surface 3a by the vehicle occupant based on the detection of the lifting load or the impact load, the ECU starts setting the forward movement start timing, the movement speed, the movement distance, and the like for the headrest front portion 5b. The ECU 7 sets the forward movement start timing, the movement speed, the movement distance, and the like for the headrest front portion 5b in accordance with the magnitude of the impact applied to the seat 3. In other words, as the urgency for protecting the vehicle occupant becomes higher, the ECU 7 advances the movement start timing of the headrest front portion 5b and increases the movement speed of the headrest front portion 5b. Further, as the movement of the load applied to the seating surface 3a becomes greater, the ECU 7 increases the movement distance of the headrest front portion 5b.

The headrest 5 is provided with an extendible drive mechanism 8 arranged between the headrest rear portion 5a and the headrest front portion 5b, a motor 8a serving as a drive means (drive unit) for driving the drive mechanism 8, and a head detection means (head detection unit) or a head detection sensor 9. When the drive mechanism 8 is extended by the driving force of the motor 8a, the headrest front portion 5b moves away from the headrest rear portion 5a. Further, when the drive mechanism 8 is retracted by the driving force of the motor 8a, the headrest front portion 8b moves toward the headrest rear portion 5a.

The motor 8a is connected to the ECU 7. When the ECU 7 determines that movement of the load applied to the seating surface 3a due to an impact applied to the vehicle based on the detection signals input from the sensor device 6, the ECU drives the motor 8a to move the headrest front portion 5b toward the front, that is, toward the extended position 5Y.

If the vehicle seat apparatus 1 is, for example, a front vehicle occupant's seat in which the seated vehicle occupant faces toward the front of the vehicle, when an impact is applied from the rear of the vehicle, the vehicle occupant's body above the waist is forced against the seat back 4 with the vehicle occupant's head remaining at the same position as shown in the state of FIG. 2(b). In this state, the ECU 7 moves the headrest front portion 5b toward the extended position 5Y to protect the vehicle occupant's head.

If the vehicle seat apparatus 1 is a rotational seat arranged so that the seated vehicle occupant faces the rear of the vehicle, when an impact is applied to the vehicle from the rear, the ECU 7 moves the headrest front portion 5b toward the extended position 5Y. If the impact is applied to the vehicle from the rear, the vehicle occupant's body above the waist is once thrown toward the front of the vehicle seat apparatus 1 and then forced against the seat back 4 with the vehicle occupant's head remaining at the same position as shown in the state of FIG. 2(b) due to the reaction of the impact.

Therefore, the ECU 7 may start the movement of the headrest front portion 5b to start when a fixed time elapses after the impact. However, since the vehicle occupant's body above the waist is thrown toward the immediately after the impact, there should be no problem in starting the movement of the headrest front portion 5b immediately after the impact.

The head detection sensor 9 detects contact of the head of the vehicle occupant seated on the seat 3 with the headrest front portion 5b. The head detection sensor 9 is formed by a touch sensor arranged on the front surface of the headrest front portion 5b.

When the head detection sensor 9 detects contact of the vehicle occupant's head with the headrest front portion 5b while the headrest front portion 5b is moving toward the extended position 5Y, the ECU 7 immediately stops the movement of the headrest front portion 5b. The position at which the headrest front portion 5b is stopped is referred to as a head position 5H (see FIG. 2(b)). If contact of the vehicle occupant's head with the headrest front portion 5b is not detected, the ECU 7 stops the movement of the headrest front portion 5b at the position corresponding to the determination result of the above-described seated state.

In this manner, when determining movement of the load applied to the seating surface 3a due to an impact that is applied to the vehicle, the ECU 7 moves the headrest front portion 5b from the retracted position 5X toward the extended position 5Y in order to protect the vehicle occupant's head with the headrest front portion 5b. Then, the ECU 7 controls the motor 8a to return the headrest front portion 5b to the retracted position 5X.

The electrical configuration of the vehicle seat apparatus 1 will now be described.

As shown in FIG. 3, the vehicle seat apparatus 1 includes the ECU 7, the load sensor device 6 (the two first load sensors 6X and the two second load sensors 6Y) connected to the ECU 7, the motor 8a, the head detection sensor 9, and a power supply device 10.

Each of the load sensors 6X and 6Y includes a gauge 6a, of which resistance changes when receiving pressure in accordance with the level of the pressure, and a conversion circuit 6b, which converts the change in resistance of the gauge 6a to an electric voltage value. The change in resistance of the gauge 6a is converted into the electric voltage value by the conversion circuit 6b. Each of the load sensors 6X and 6Y outputs the electric voltage value obtained by converting the change in resistance of the gauge 6a to the ECU 7. The ECU 7 detects the load applied to the seating surface 3a of the seat 3 based on the electric voltage value (detection signal) input from each of the load sensors 6X and 6Y.

The ECU 7 includes a CPU 11, a power supply circuit 12 connected to the CPU 11, a head detection sensor circuit 14, and a drive circuit 13.

The CPU 11 is connected to the power supply device 10 by an ignition switch (IGSW). The ignition switch is activated to supply the CPU 11 with electrical power from the power supply device 10 via the power supply circuit 12.

The CPU 11 is connected to the motor 8a by the drive circuit 13 and controls the drive circuit 13 to drive the motor 8a. The CPU 11 is connected to the head detection sensor 9 by the head detection sensor circuit 14 and determines whether or not contact of the vehicle occupant's head with the headrest front portion 5b was detected based on the detection signal input from the head detection sensor 9.

The processing procedures for moving the headrest front portion 5b to the front when determining movement of the load applied to the seating surface 3a due to an impact applied to the vehicle will now be described.

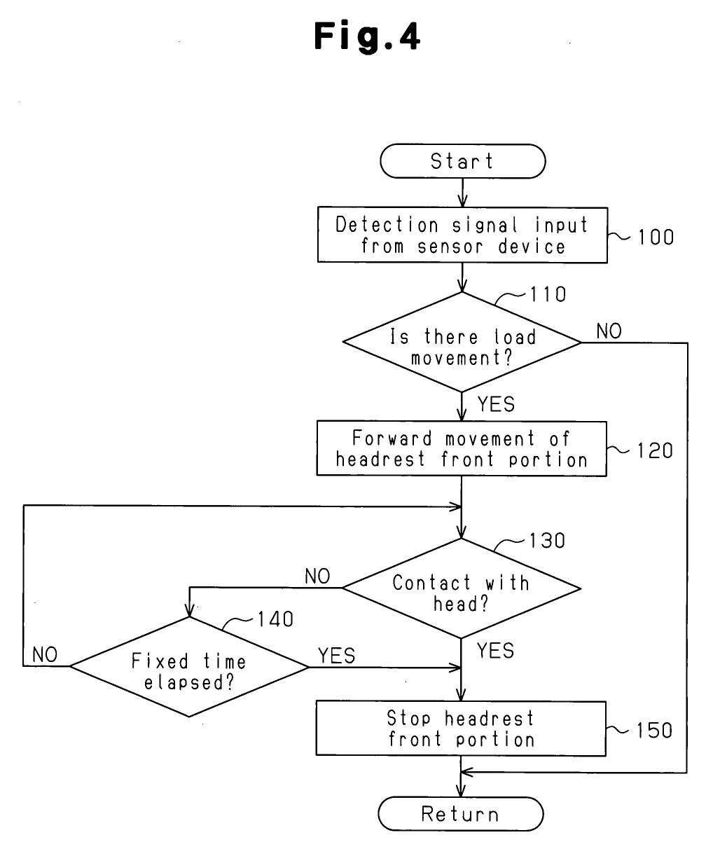

As shown in FIG. 4, in step 100, the ECU 7 first receives detection signals input from the load sensor device 6.

Then, in step 110, the ECU 7 determines from the detection signal whether or not there was movement in the load applied to the seating surface 3a by the vehicle occupant seated on the seat 3 due to an impact applied to the vehicle. In this state, the ECU 7 determines whether or not the first sensors 6X or the second sensor 6Y detected the lifting load or the impact load.

When determining that there was load movement (step 110: YES), in step 120, the ECU 7 starts moving the headrest front portion 5b toward the front. When determining that there was no load movement (step 110: NO), the ECU 7 ends the processing.

After starting forward movement of the headrest front portion 5b in step 120, the ECU 7 in step 130 determines whether or not the vehicle occupant's head is in contact with the headrest front portion 5b based on the detection signal input from the head detection sensor 9. When determining that the vehicle occupant's head is not in contact with the headrest front portion (step 130: NO), the ECU 7 in step 140 determines whether a fixed time has elapsed from when forward movement of the headrest front portion 5b started. The fixed time, which is set to the time required to move the headrest front portion 5b to a predetermined position in accordance with the state of the vehicle occupant seated on the seat 3, is set to a few seconds.

When determining that the fixed time has not elapsed (step 140: NO), the ECU 7 again in step 130 determines whether or not the vehicle occupant's head is in contact with the headrest front portion 5b. When determining that the fixed time has elapsed (step 140: YES), the ECU 7 in step 150 stops the movement of the headrest front portion 5b and then ends the processing. In this case, the headrest front portion 5b stops at a predetermined position, which corresponds to the seated state of the vehicle occupant.

Further, in step 130, when determining that the vehicle occupant's head is in contact with the headrest front portion (step 130: YES), the ECU 7 in step 150 stops the movement of the headrest front portion 5b and then ends the processing. In this case, the headrest front portion 5b stops at the head position 5H (see FIG. 1).

After the headrest front portion 5b provides protection to the vehicle occupant's head, the ECU 7 moves the headrest front portion 5b back to the retracted position 5X. The ECU 7 repeats the processes of steps 100 to 150 shown in FIG. 4 as long as the ignition switch of the vehicle is activated.

The first embodiment of the present invention has the advantages described below.

When the ECU 7 determines from the detection signals input from the sensor device 6 that there was movement of the load applied to the seating surface 3a by the vehicle occupant seated on the seat 3, the ECU moves the headrest front portion 5b toward the extended position 5Y. In other words, the ECU 7 moves the headrest front portion 5b toward the extended position 5Y in accordance with the load applied to the seat 3. This ensures operation of the headrest 5.

The ECU 7 determines that an impact was applied to the vehicle seat apparatus 1 from the rear based on the load actually applied to the seat 3. Thus, this ensures recognition of the impact. For example, the ECU 7 detects an impact and moves the headrest front portion 5b even if an impact detection means (impact detection unit) is located at a position separated from the vehicle seat apparatus 1 and the impact detection means erroneously recognizes an impact due to one reason or another. Thus, even in a vehicle that does not have the impact detection means at the rear part of the vehicle, impact applied to the vehicle can be detected with only the vehicle seat apparatus 1 to move the headrest front portion 5b and reduce whiplash injuries that may be inflicted to the seated vehicle occupant.

The ECU 7 determines the state of the vehicle occupant seated on the seat 3 and moves the headrest front portion 5b in accordance with the determination result. Therefore, the timing for starting movement of the headrest front portion 5b toward the extended position 5Y and the movement speed and movement distance of the headrest front portion 5b may be changed, for example, in accordance with the build, posture, or the like of the vehicle occupant seated on the seat 3. Accordingly, the ECU 7 moves the headrest front portion 5b so as to optimally protect the head of the vehicle occupant seated on the seat 3.

When the vehicle occupant seated on the seat 3 is moved due to the impact, the ECU 7 moves the headrest front portion 5b to a position at which the head of the vehicle occupant seated on the seat 3 comes into contact with the headrest front portion. That is, the headrest front portion 5b stops at a proper position where load would not be applied to the vehicle occupant's neck or the like. Accordingly, the vehicle occupant's head is protected in an optimal manner during a collision.

The first embodiment may be modified in the following manner.

The load detection means for detecting the load applied to the seat 3 may be a pressure sensor or the like that utilizes the piezoelectric effect of a crystal or the like instead of the load sensor device 6 including gauges 6a.

The head detection sensor 9 may detect the distance between the vehicle occupant's head and the headrest front portion 5b instead of detecting contact of the headrest front portion 5b with the head of the vehicle occupant seated on the vehicle seat apparatus 1. In this case, when the distance between the vehicle occupant's head and the headrest front portion 5b becomes less than or equal to a predetermined value (for example, less than about 5 mm), the ECU 7 stops forward movement of the headrest front portion 5b.

The quantity of the first sensors 6X is not limited to two and may be one or more than three. The quantity of the second sensors 6Y is not limited to two and may be one or more than three.

The drive means for driving the headrest front portion 5b may be a spring type or solenoid type drive means instead of the motor 8a.

The head detection sensor 9 may be formed by an optical sensor, a capacitance type sensor, an ON/OFF type sensor, or the like instead of the touch sensor.

The head detection sensor 9 may be omitted. In such a case, the movement distance and movement speed of the headrest front portion 5b during movement toward the extended position 5Y predetermined.

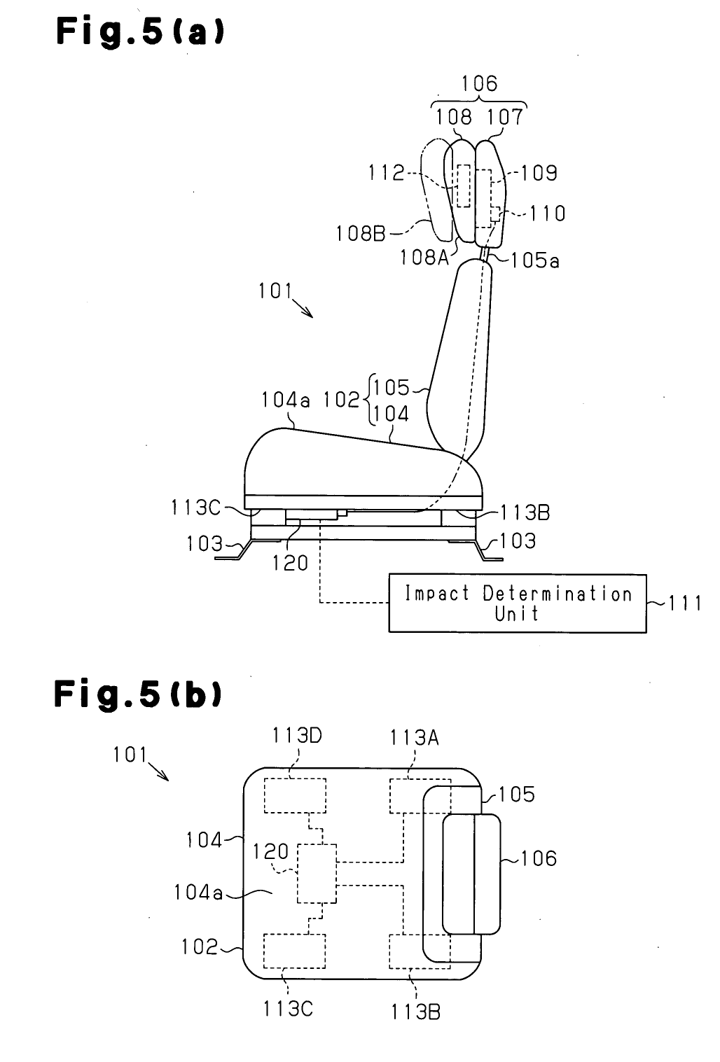

A second embodiment of the present invention will now be described with reference to FIGS. 5(a) to 7.

FIG. 5(a) is a side view showing a vehicle seat apparatus 101 of the second embodiment, and FIG. 5(b) is a plane view thereof. The vehicle seat apparatus 101 is arranged at the front vehicle occupant side of the vehicle.

As shown in FIG. 5(a), the vehicle seat apparatus 101 includes a vehicle seat 102. The vehicle seat 102 includes a seating portion 104, a seat back 105 supported on the seating portion 104 in an inclinable manner, and a headrest 106 supported by the seat back 105. The seating portion 104 is fixed to seat brackets 103 secured to the vehicle body.

The headrest 106 includes a headrest rear portion 107 serving as a base portion and a headrest front portion 108 serving as a movable portion that is movable relative to the headrest rear portion 107. The headrest rear portion 107 is supported by a headrest stay 105a provided arranged at a top portion of the seat back 105. The headrest front portion 108 is movable between a retracted position 108A proximate to the headrest rear portion 107 as shown by the solid line in FIG. 5(a) and an extended position 108B distant from the headrest rear portion 107 as shown by the double-dashed line in FIG. 5(a). When the vehicle is in a normal driving state, the headrest front portion 108 is located at the retracted position 108A.

As shown in FIGS. 5(a) and 5(b), the vehicle seat apparatus 101 includes an extendible drive mechanism 109 arranged between the headrest rear portion 107 and the headrest front portion 108, a motor 110 serving as a drive means (drive unit) for driving the drive mechanism, an impact determination unit 111, a head detection sensor 112, four load sensors 113A, 113B, 113D, and 113D serving as load detection means (load detection units), and an ECU 120 serving as a control means (control unit) for controlling the motor 110.

When the motor 110 drives and extends the drive mechanism 109, the headrest front portion 108 moves away from the headrest rear portion 107. When the motor 110 drives and retracts the drive mechanism 109, the headrest front portion 108 moves toward the headrest rear portion 107.

The impact determination unit 111 corresponds to an impact detection means (impact detection unit), which detects an impact applied to the vehicle from the rear, and an impact prediction means (impact prediction unit) for predicting an impact applied to the vehicle from the rear. In this embodiment, the impact determination unit 111 is connected to a radar (not shown) arranged on a rear bumper of the vehicle to comprehensively determine the relative speed and distance between the vehicle and the following vehicle and the speed of the vehicle based on a signal input from the radar to determine whether there is a possibility of a collision with the following vehicle.

The head detection sensor 112 detects contact of the head of the vehicle occupant seated on the vehicle seat 102 with the headrest front portion 108. The head detection sensor 112 is formed by a touch sensor and arranged on a front surface of the headrest front portion 108.

The load sensors 113A, 113B, 113C, and 113D are fixed to the seat bracket 103 to detect load characteristics applied to the vehicle seat 102. In the present embodiment, two first load sensors 113A and 113B are arranged at the rear side of the seating portion 104 (toward the seat back 105), and two second load sensors 113C and 113D are arranged at the front side of the seating portion 104. The load sensors 113A, 113B, 113C, and 113D detect the load applied to a seating surface 104a of the seating portion 104. Each of the load sensors 113A, 113B, 113C, 113D includes a strain detection element such as a strain gauge to electrically detect a deflection amount of the strain detection element that corresponds to the load applied to the seating surface 104a of the seating portion 104.

The ECU 120, which is connected to the motor 110 and the impact determination unit 111, controls the motor 110 so as to move the headrest front portion 108 from a retracted position 108A to an extended position 108B during or before a collision occurs at the rear of the vehicle based on an output signal from the impact determination unit 111.

The ECU 120 also determines the subject on the vehicle seat 102 based on the load characteristics detected by the load sensors 113A, 113B, 113C, and 113D and permits or prohibits movement of the headrest front portion 108 in accordance with the determination result.

More specifically, the ECU 120 determines whether or not an adult vehicle occupant is seated on the vehicle seat 102 and permits movement of the headrest front portion 108 when determining that an adult vehicle occupant is seated. An adult vehicle occupant is a vehicle occupant whose head is located at generally the same height as that of the headrest front portion 108.

When determining that an adult vehicle occupant is not seated on the vehicle seat 102, the ECU 120 prohibits movement of the headrest front portion 108. Examples in which the ECU 120 determines an adult vehicle occupant is not seated on the vehicle seat 102 include a case in which the head of the vehicle occupant seated on the vehicle seat 102 is not located at the same height as the headrest front portion 108, a case in which the vehicle occupant is seated on a CRS, and a case in which there is no subject on the vehicle seat 102.

The ECU 120 also stops the movement of the headrest front portion 108 when the head detection sensor 112 detects that the vehicle occupant's head contacts the headrest front portion 108 as the headrest front portion 108 moves toward the extended position 108B. The ECU 120 permits the headrest front portion 108 to move to the extended position 108B if contact is not detected between the headrest front portion 108 and the vehicle occupant's head.

The electrical configuration of the above stated vehicle seat apparatus 101 will now be described.

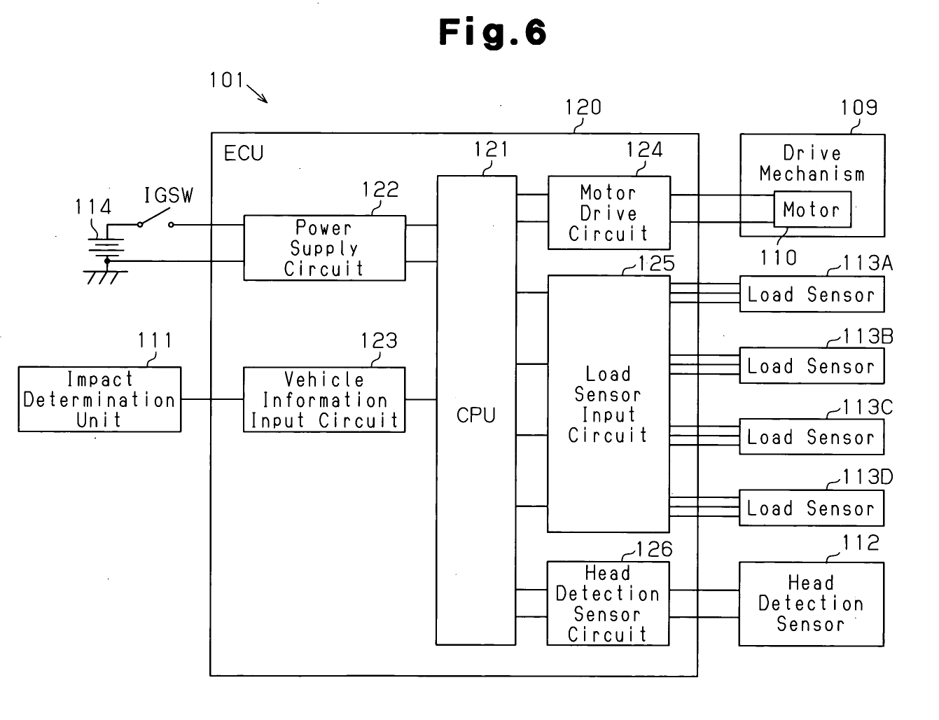

As shown in FIG. 6, the vehicle seat apparatus 101 is includes the ECU 120, the motor 110 connected to the ECU 120, the load sensors 113A, 113B, 113C, and 113D, a head detection sensor 112, a power supply device 114, and an impact determination unit 111.

The ECU 120 includes a CPU 121, a power supply circuit 122 connected to the CPU 121, a vehicle information input circuit 123, a motor drive circuit 124, a load sensor input circuit 125, and a head detection sensor circuit 126.

The CPU 121 is connected to the power supply device 114 via an ignition switch (IGSW). The ignition switch is activated to supply the CPU 121 with electric power from the power supply device 114 via the power supply circuit 122. The CPU 121 is connected to the impact determination unit 111 via the vehicle information input circuit 123 to receive vehicle information such as the state at the rear of the vehicle or the state of the following vehicle from the impact determination unit 111.

The CPU 121 is connected to the motor 110 via the motor drive circuit 124 to control the motor drive circuit 124 and drive the motor 110. The CPU 121 is connected to the load sensors 113A, 113B, 113C, and 113D via a load sensor input circuit 125. The CPU 121 receives detection signals from the load sensors 113A, 113B, 113C, and 113D to determine the subject on the seating portion 104 based on the load characteristics applied to the seating surface 104a of the seating portion 104. More specifically, the CPU 121 reads load signals from the load sensors 113A, 113B, 113C, and 113D to determine the subject on the seating portion 104 based on the load value detected by each of the load sensors 113A, 113B, 113C, and 113D the total load value of the detected load values.

In the present embodiment, the CPU 121 first determines whether or not the subject on the seating portion 104 is a person based on the distribution of the detected load values of the load sensors 113A, 113B, 113C, and 113D. Generally, when a person is seated on the vehicle seat 102, the person's back is supported by the seat back 105. This increases the distribution of the detected load values of the first load sensors 113A and 113B at the rear side of the seating portion 104. Accordingly, when the detected load values of the load sensors 113A and 113B at the rear side of the seating portion 104 is greater than the detected load values of the second sensors 113C and 113D at the front side of the seating portion 104, the CPU 121 determines that the subject on the seating portion 104 is a person.

The CPU 121 also determine whether or not a CRS or a booster seat is mounted on the vehicle seat 102 based on a comparison between the distribution of the detected load values of the load sensors 113A, 113B, 113C, and 113D and the distribution of the load values detected when a CRS or booster seat is mounted on the vehicle seat 102. The booster seat includes a seat or seat and seat back that can be mounted on the vehicle seat 102 in the same manner as the CRS to protect a person who is too small to directly sit on the vehicle seat 102 during a collision.

When determining that the subject on the seating portion 104 is a person, the CPU 121 compares a predetermined threshold with the total load value. Then, the CPU 121 determines that the subject on the seating portion 104 is an adult vehicle occupant if the total load value is greater than or equal to the threshold and determines that the subject on the seating portion 104 is a child if the total load value is less than the threshold.

The CPU 121, which is connected to the head detection sensor 112 via the head detection sensor circuit 126, determines whether or not contact of the vehicle occupant's head with the headrest front portion 108 was detected based on the detection signal from the head detection sensor 112.

A process executed by the CPU 121 of the ECU 120 in the vehicle seat apparatus 101 will now be described.

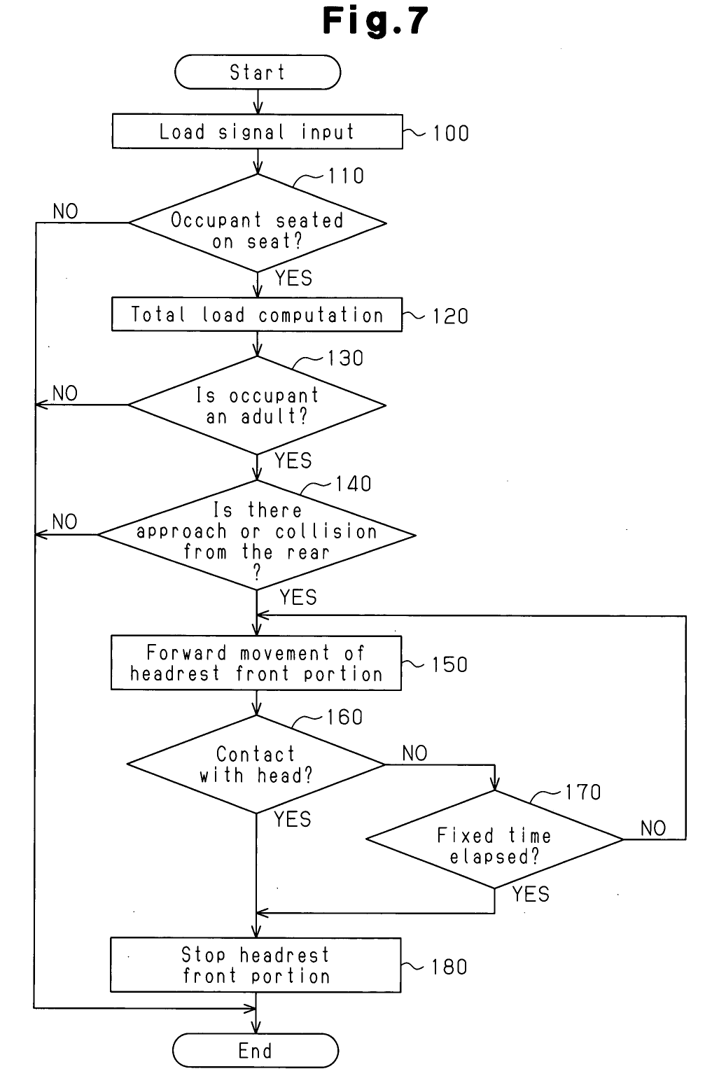

As shown in FIG. 7, in step 100, the CPU 121 first receives the load signals from the load sensors 113A, 113B, 113C, and 113D. Subsequently, in step 110 the CPU 121 determines whether or not a vehicle occupant is seated on the vehicle seat 102 based on the distribution of the detected load values of the load sensors 113A, 113B, 113C, and 113D. When it is determined that a vehicle occupant is seated on the vehicle seat 102 (step 110: YES), the CPU 121 adds the detected load values of the load sensors 113A, 113B, 113C, and 113D to calculate the total load value. When determining that no vehicle occupant is seated on the vehicle seat 102 (step 110: NO), the CPU 121 ends the processing. In this case, a CRS or booster seat is mounted on the vehicle seat 102 or there is no subject on the vehicle seat 102.

Then, in step 130, the CPU 121 determines whether or not the vehicle occupant seated on the vehicle seat 102 is an adult. The CPU 121 compares the predetermined threshold with the total load value calculated in step 120, determines that the vehicle occupant is an adult if the total load value is greater than the threshold, and determines that the vehicle occupant is not an adult if the total load value is less than the threshold.

When determining that the vehicle occupant is an adult (step 130: YES), the CPU 121 in step 140 determines whether or not a vehicle is approaching from the rear or whether or not or collision occurred based on the signal output from the impact determination unit 111. When determining that the vehicle occupant is not an adult (step 130: NO), the CPU 121 ends the processing. In this case, the vehicle occupant on the vehicle seat 102 has a build in which the head is lower than the headrest front portion 108.

When determined that a vehicle is approaching from the rear or that a collision has occurred (step 140: YES), the CPU 121 in step 150 starts the forward movement of the headrest front portion 108. When determining that there is not vehicle approaching from the rear and that no collision has occurred (step 140: NO), the CPU 121 ends the processing.

After the headrest front portion 108 starts moving to the front in step 150, the CPU 121 determines in step 106 whether or not the vehicle occupant's head is in contact with the headrest front portion 108. When determining that there is no contact between the vehicle occupant's head and the headrest front portion (step 160: NO), the CPU 121 in step 170 determines whether or not a fixed time has elapsed from when the headrest front portion 108 started to move to the front. The fixed time is set at the time required for full stroke movement of the headrest front portion 108 and is about several seconds.

When determining that the fixed time has not elapsed (step 170: NO), the CPU 121 returns again to step 150. When determining that the fixed time has elapsed (step 170: YES), the CPU 121 in step 180 stops the movement of the headrest front portion 108 and then ends the processing.

When determining in step 160 that there is contact with the vehicle occupant's head (step 160: YES), the CPU 121 in step 180 stops the movement of the headrest front portion 108 and then ends the processing. The CPU 121 repeats the processes of step 100 to step 180 shown in FIG. 7 as long as the ignition switch is activated.

The second embodiment has the advantages described below.

The ECU 120 determines the subject on the vehicle seat 102 based on the load characteristics applied to the vehicle seat 102 and permits or prohibits the movement of the headrest front portion 108 in accordance with the determination result. Accordingly, the headrest 106 is moved in accordance with the subject on the vehicle seat 102.

If an adult vehicle occupant is seated on the vehicle seat 102, the headrest front portion 108 is moved when or before a collision occurs at the rear of the vehicle. Thus, an adult vehicle occupant's head is protected in an optimal manner even if an impact is applied to the vehicle. This reduces whiplash injuries.

When an adult vehicle occupant is not seated on the vehicle seat 102, the headrest front portion 108 does not move when or before a collision occurs at the rear of the vehicle. This prevents undesirable situations that may occur when the headrest front portion 108 moves. Further, unnecessary operations of the headrest front portion 108 are eliminated.

The second embodiment may be modified in the following manner.

In the second embodiment, the impact determination unit 111 serving as the impact detection means for detecting a collision at the rear of the vehicle is arranged independently from the load sensors 113A, 113B, 113C, and 113D. However, the impact determination unit 111 may be omitted, and the load sensors 113A, 113B, 113C, and 113D may be used as the impact detection means. In other words, a collision at the rear of the vehicle may be detected based on the load characteristics detected by the load sensors 113A, 113B, 113C, and 113D.

For example, if there is a collision at the rear of the vehicle and weight movement of the vehicle occupant occurs on the seating surface 104a of the seating portion 104, the load values detected by the load sensors 113A and 113B arranged at the rear side of the vehicle increases from the normal driving state. Accordingly, a threshold corresponding to the predicted load values when an impact is applied to the vehicle from the rear may be set beforehand to determine the occurrence of a collision at the rear of the vehicle when the load values detected by the load sensors 113A and 113B becomes greater than the threshold. This would simplify the structure in comparison with when the impact detection means and the load sensors are formed by different members.

The load detection means may be a pressure sensor utilizing a piezoelectric effect of a crystal or the like instead of the load sensors 113A, 113B, 113C, and 113D, which include strain elements such as strain gauges.

The quantity of the first load sensors 113A and 113B is not limited to two and may be one or more than three. The quantity of the second load sensors 113C and 113D is not limited to two and may be one or more than three.

The load detection means may be, for example, ON/OFF type load sensors arranged in a matrix on the seating surface 104a of the seating portion 104 instead of the load sensors 113A, 113B, 113C, and 113D. In this case, the CPU 121 determines the subject on the vehicle seat 102 through pattern matching. Further, a load sensor may be arranged in the seat back 105. It is only required that the CPU 121 be able to determine whether or not the subject on the vehicle seat 102 is an adult vehicle occupant.

The drive means for driving the headrest front portion 108 may be a spring type drive means or a solenoid type drive means instead of the motor 110.

The head detection sensor 112 may be omitted. In this case, the movement distance and movement speed for when the headrest front portion 108 moves toward the extended position 108B is set beforehand.

The vehicle seat apparatus 101 may be applied to vehicle seats other front vehicle occupant's seat, such as the driver's seat and the rear seats.

1. A seat apparatus arranged in a vehicle, the seat apparatus comprising:
a seat having a seating surface;
a seat back arranged at a rear part of the seat;
a headrest supported by the seat back, the headrest including a base portion and a movable portion that is movable relative to the base portion, wherein the movable portion moves between a retracted position proximate to the base portion and an extended position distant from the base portion;
a drive unit for driving the movable portion;
a load detection unit for detecting a load applied to the seating surface of the seat; and
a control unit for determining from a detection signal input by the load detection unit whether or not the load applied to the seating surface by a vehicle occupant seated on the seat has moved and controlling the drive unit to move the movable portion toward the extended position when determining that the load applied to the seating surface has moved.

2. The seat apparatus according to claim 1, wherein:
the load detection unit includes at least two load sensors arranged on the seat spaced apart from each other in the forward/rearward direction of the seat; and
the control unit determines the state of a vehicle occupant seated on the seat based on detection signals input from the two load sensors and controls the movement of the movable portion based on the determination.

3. The seat apparatus according to claim 1, wherein:
the movable portion includes a head detection unit for detecting contact of the head of a vehicle occupant seated on the seat with the movable portion; and
the control unit stops the movement of the movable portion if the head detection unit detects contact of the vehicle occupant's head with the movable portion when the movable portion is moving toward the extended position.

4. The seat apparatus according to claim 1, wherein:
the movable portion includes a head detection unit for detecting the distance between the head of a vehicle occupant seated on the seat and the movable portion; and
the control unit stops the movement of the movable portion if the distance between the vehicle occupant's head and the movable portion becomes less than or equal to a predetermined value when the movable portion is moving toward the extended position.

5. The seat apparatus according to claim 1, wherein the control unit determines the subject on the seat from the load detected by the load detection unit and permits or prohibits movement of the movable portion in accordance with the determination.

6. The seat apparatus according to claim 1, wherein the control unit determines whether or not an adult vehicle occupant is seated on the seat from the load detected by the load detection unit and permits movement of the movable portion when determining that an adult vehicle occupant is seated.

7. The seat apparatus according to claim 6, wherein:
the load detection unit includes a first load sensor for detecting load applied to a front part of the seating surface and a second load sensor for detecting load applied to a rear part of the seating surface; and
the control unit determines that an adult vehicle occupant is seated on the seat when the load detected by the second load sensor is greater than the load detected by the first load sensor and the total of the loads detected by the first and second load sensors is greater than a predetermined threshold.

8. The seat apparatus according to claim 6, wherein the control unit prohibits movement of the movable portion when determining that an adult vehicle occupant is not seated on the seat.

9. The seat apparatus according to claim 1, further comprising an impact detection unit for detecting impact applied to the vehicle from the rear of the vehicle, wherein the control unit controls the drive unit to move the movable portion toward the extended position when an adult vehicle occupant is seated on the seat and the impact detection unit detects an impact applied to the vehicle from the rear of the vehicle.

10. The seat apparatus according to claim 9, wherein the impact detection unit is formed by the load detection unit.

11. The seat apparatus according to claim 1, further comprising an impact prediction unit for predicting an impact to the vehicle from the rear of the vehicle, wherein the control unit controls the drive unit to move the movable portion toward the extended position when an adult vehicle occupant is seated on the seat and the impact prediction unit predicts an impact to the vehicle from the rear of the vehicle.

12. The seat apparatus according to claim 11, wherein the control unit controls the drive unit so that the movable portion stops moving when a fixed time elapses from when the movable portion starts moving toward the extended position.
